(19) United States
(12) Patent Application Publication
(10) Pub. No.: US 2026/0289836 A1
(43) Pub. Date: Sep. 24, 2026

(54) AUTOMATED POLYGON SELECTION OF MAP REGION

(71) Applicant: Quantarium Group, LLC, Bellevue, WA (US)

(72) Inventors: Andrei T. Aron, Woodinville, WA (US); Diana Minzat, lasi (RO); Petru Cociorva, Redmond, WA (US); Adrian Fanaru, Sammamish, WA (US)

(21) Appl. No.: 19/086,972

(22) Filed: Mar. 21, 2025

(51) Int. Cl. G06T 11/20; G06Q 50/16; G06T 7/11; G06T 11/00

(52) U.S. Cl. CPC G06T 11/23; G06Q 50/16; G06T 7/11; G06T 11/10; G06T 2200/24; G06T 2207/10024

(57) ABSTRACT

Systems and methods are disclosed for generating a polygona selection of a map region for geographic clustering delineation. In certain embodiments, a method may comprise executing a polygon map delineation operation via a computing system to perform automated geographic clustering based on computer vision at runtime. The method may include generating a heatmap image of a plurality of map entries based on a selected attribute, including assigning colors to the map entries based on their corresponding value for the selected attribute, performing image segmentation on the heatmap image to determine a grouping of map entries sharing similar values for the selected attribute, generating a polygon boundary around the grouping of map entries, and performing operations limited to the grouping of map entries based on the polygon boundary.

### TECHNICAL FIELD

Various embodiments of the present technology generally relate to computer and software systems and services, and in particular to systems and methods for generating a polygon on a map to outline groups of similar map entries based on heatmap representations of the map entries.

### SUMMARY

In certain embodiments, a method may comprise executing a polygon map delineation operation via a computing system to perform automated geographic clustering based on computer vision at runtime. The method may include generating a heatmap image of a plurality of map entries based on a selected attribute, including assigning colors to the map entries based on their corresponding value for the selected attribute, performing image segmentation on the heatmap image to determine a grouping of map entries sharing similar values for the selected attribute, generating a polygon boundary around the grouping of map entries, and performing operations limited to the grouping of map entries based on the polygon boundary.

In certain embodiments, a memory device may store instructions that, when executed, cause a processor to execute a polygon map delineation operation via a computing system to perform automated geographic clustering based on computer vision at runtime. When executed, the instructions may cause the processor to generate a heatmap image of a plurality of map entries based on a selected attribute, including assigning colors to the map entries based on their corresponding value for the selected attribute, perform image segmentation on the heatmap image to determine a grouping of map entries sharing similar values for the selected attribute, generate a polygon boundary around the grouping of map entries, and perform operations limited to the grouping of map entries based on the polygon boundary.

In certain embodiments, an apparatus may comprise a processor and a memory device storing instructions that cause the processor to execute a polygon map delineation operation to perform automated geographic clustering based on computer vision at runtime. The apparatus may generate a heatmap image of a plurality of map entries based on a selected attribute, including assigning colors to the map entries based on their corresponding value for the selected attribute, perform image segmentation on the heatmap image to determine a grouping of map entries sharing similar values for the selected attribute, generate a polygon boundary around the grouping of map entries, and perform operations limited to the grouping of map entries based on the polygon boundary.

### BRIEF DESCRIPTION OF THE DRAWINGS

FIG. 1 is a diagram of an example system configured to perform automated polygon selection of a map region, in accordance with certain embodiments of the present disclosure;

FIG. 2 depicts an example user interface for a system configured to perform automated polygon selection of a map region, in accordance with certain embodiments of the present disclosure;

FIG. 3 depicts an example process flow diagram of a system configured to perform automated polygon selection of a map region, in accordance with certain embodiments of the present disclosure;

FIG. 4 depicts a flowchart of an example method for automated polygon selection of a map region, in accordance with certain embodiments of the present disclosure; and

FIG. 5 is a diagram of an example system configured to perform automated polygon selection of a map region, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

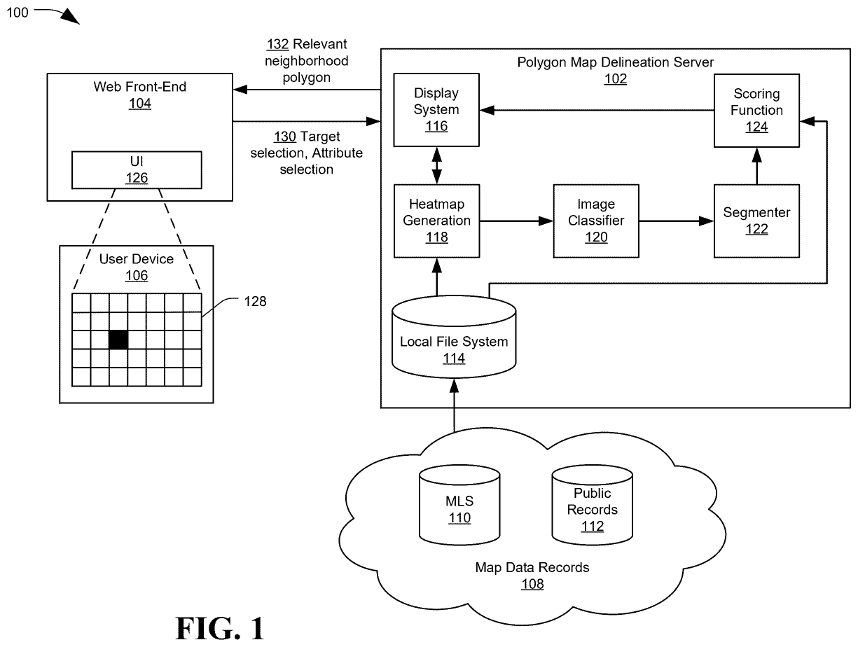

FIG. 1 is a diagram of an example system 100 configured to perform automated polygon selection of a map region, in accordance with certain embodiments of the present disclosure. In particular, system 100 provides an example set of elements for performing geographic clustering, including determining the contours of a grouping of map elements based on a heatmap representation of the elements, for example by generating a polygon around the grouping. System 100 may include a polygon map delineation server 102, a web front-end 104, a user device 106, and one or more map data record sources 108. Polygon map delineation server 102, web front-end 104, user device 106, map data sources 108, or any of their sub-components, may each be implemented via one or more computing systems, servers, or other processing devices, data storage or memory devices, or other computing apparatuses. The computing systems may implement functional modules to perform the operations described herein. In some embodiments, the elements of system 100 may include cloud computing modules, such as cloud servers configured to host and implement computational pods for performing the described operations. The systems may communicate over one or more network connections, either wired or wireless, to provide and receive data.

Geographic clustering, such as by determining groupings of map elements sharing similar properties or alike features and drawing a polygon around the groupings, can be useful in a variety of applications. For example, such polygonal areas may be used in many instances in the real-estate verticals, including in appraisal, automated value models (AVMs), and trend assessment. Examples may be provided herein directed to real estate applications of the disclosed systems and processes, but the applications are not limited thereto. For example, geographic clustering may be used for detecting areas with similar land use patterns, identifying areas with high concentrations of flora or fauna, identifying crime hot spots, identifying areas with high unemployment, or other applications. Computer vision techniques may be desirable for polygonal area deduction through the use of heat map representations of map elements, because deterministic techniques can struggle with color outliers, gaps, and gradients.

Identifying the boundaries or groupings of relevant map entries can be very difficult and time consuming to attempt manually. Even when a user has access to a heatmap to visually reflect value differences between map entries, there may not be a good way to capture a grouping of relevant map entries, especially when that grouping is in an irregular shape. The proposed solutions can create a delineation or boundary around relevant map entries automatically, even when that boundary is highly irregular. The polygon boundary can be used to determine latitude and longitude coordinates for identifying only those map entries that fall within the polygon boundary. The proposed solutions can therefore perform geographic clustering via the polygon boundary delineation at runtime (e.g., on-the-fly) using computer vision techniques.

In an example embodiment, a user may wish to identify relevant comparable properties (comps) for a target property. The user may utilize a user interface of a polygon map delineation server 102 to identify one or more attributes by which to group properties, such as a year-over-year value change, and to select a target property. The server 102 may generate a heatmap of year-over-year value change for properties on the map display. The heatmap may be provided to an image segmentation tool, which may identify the boundaries of “pools” or “groupings” of map entries that have similar year-over-year value changes, according to the heatmap. In particular, the image segmenter may identify the grouping of properties that include the selected target property, and draw a polygon around that property grouping. The server 102 may then identify properties falling within the polygon, thereby defining a value neighborhood from which the user may locate, or be provided with a list of, highly relevant comparable properties. Various techniques may be used to improve the relevance or quality of the produced polygon delineation, as will be discussed herein.

In the embodiment of system 100, the polygon map delineation server 102 may be configured to provide a digital map depicting map elements. The polygon map delineation server 102 may generate one or more heatmaps based on, for example, map data records 108, such as by color-coding the displayed map entries in relation to attribute values of the map entries from the records 108. For example, attributes for properties may include an estimated value of the property, a gross living area (GLA), property size, year-over-year value change, or other attributes, which information may be obtained from public or private property records. The generated heatmap may be used to perform image segmentation to identify grouped map entries having similar colors, and hence similar attribute values.

The polygon map delineation server 102 may perform heatmap generation, image segmentation, and polygon generation, or other operations automatically (e.g., on a selected schedule), in response to an instruction from an operator (e.g., an administrator of polygon map delineation server 102), in response to a request initiated via a user device 106 accessing a web front-end 104 for the polygon map delineation server 102, or according to other triggers. The polygon map delineation server 102 may include a local file system 114, display system module 116, heatmap generation module 118, image classifier module 120, segmenter module 122, and scoring function module 124.

Web front-end 104 may include a website, mobile application, or other interface via which a user may access the services and operations of polygon map delineation server 102. For example, a user may access the web front-end 104 to identify 130 a target property, and to select filters for parameters or attributes of properties for which the user wishes to perform geographic clustering or obtain a polygon around a selected set of map entries. The web front-end 104 may also receive information 132, such as a relevant “neighborhood” or geographic clustering polygon around a group of map entries, and potentially related information such as details of map entries that fall within the polygon, comparable property suggestions, or other data. The web front-end 104 may include a user interface (UI) module 126, such as a graphical user interface (GUI) via which a user may input data, interact with maps and tables, and receive data.

User device 106 may include any computing device via which a user may access the UI 126 of the web front-end 104. For example, user device 106 may include a smartphone or tablet, a personal computer or laptop, a set-top box or smart television, or other computing terminal. The user device 106 may have input functionality such as a touchscreen, mouse, keyboard, pointer device, or other input systems, as well as one or more output or displays, such as a visual display screen 128.

Map data records 108 may include one or more data repositories of details on map entries, such as real property details. The map data records 108 may include any combination of private databases and publicly available databases that are accessible by polygon map delineation server 102, such as due to being hosted on the internet with access available for free or for a fee. Example map data records 108 may include an MLS (multiple listing source) database 110, and a public records database 112. Public records databases 112 may be available for various states, cities, counties, municipalities, or other regions, and may include property records that are recorded to establish chain of title to various properties within the region. Example property record data items may include property address or legal description, date of sale, sale price, square footage of a plot of land, square footage of any buildings on the property, a number of bedrooms and bathrooms, a year the building was built, a number of floors, whether a home includes a garage or pool, how recently or well-updated a home was, or other factors that may be relevant to property comparison, valuation, or appraisal.

In an example embodiment, polygon map delineation server 102 may obtain map entry details from map data record sources 108, and may store the records to a local file system 114. Local file system 114 may be a private or proprietary memory device, database, data lake, or other data store and may not necessarily be locally situated with any other component of polygon map delineation server 102. Additional information, such as proprietary map data, may also be stored to the local file system 114. Local file system 114 may also include one or more service to manage or process queries to the local file system 114, such as an optimized index service to handle queries to identify properties or other map entries that fall within a certain geographic boundary and with certain property characteristic filters applied. Polygon map delineation server 102 may be configured to retrieve the records 108 automatically (e.g., based on being configured to periodically check pre-configured web addresses for records not already in local file system 114), or the data may be stored or uploaded to local file system 114 by an operator or administrator.

Display system 116 may generate a map interface, populated by map entries, to display on user device 106 via web front-end 104. Based on inputs received from UI 126, display system 116 may adjust the displayed map details, including adjusting a zoom level, combining, separating, hiding, or revealing map entries based on zoom density, adjusting map entry displays based on selected attribute filters, displaying or hiding heatmap elements, and displaying or hiding polygon delineations generated by the polygon map delineation server 102. Display system 116 may receive user inputs 130 regarding selection of a target map entry or location, attribute selection for generation of one or more heatmaps, and display details such as zoom level, and provide the information to other components of polygon map delineation server 102, such as heatmap generation module 118.

Heatmap generation module 118 may receive the attribute selections 130 from display system 116, and map entry details from local file system 114 or map data records 108. Based on the received attribute selection and map entry data, heatmap generation module 118 may generate one or more heatmap images. For example, the heatmap generation module may determine the value range of a selected attribute for all map entries displayed on the map, and color-code the map entries into color buckets according to a map entry's specific attribute value. For example, if the heatmap generation module 118 is configured to use ten color buckets, it may assign approximately 10% of map entries into each color bucket according to the corresponding values. In other examples, the heatmap generation module 118 may evaluate the total value range of the selected attribute, and assign color values to, e.g., each 10% of the value range, and may assign map entries a color based on their value regardless of the distribution of map entries into color buckets (e.g., some buckets may have a single map entry, while other buckets may have hundreds). In some examples, adjusting a zoom level of the display may change the color distribution across the heatmap, or the heatmap color distribution may be fixed at a particular zoom level so the color-coding will not change when a user zooms in or out. If a user selects multiple attributes for heatmap generation, the heatmap generation module 118 may generate an aggregate value for the multiple attributes and produce a combined heatmap. Alternately, the heatmap generation module 118 may produce separate heatmaps for each attribute, which may be displayed or processed independently. Further, the heatmap generation module may produce a heatmap image for each of several zoom levels (e.g., centered on or near the selected target map entry), wherein the different zoom levels may have different map entry densities, and consequently different heatmap color group densities. Generated heatmaps may be displayed (e.g., on user device 106) via display system 116, or may be used internally by polygon map delineation server 102 without displaying the heatmap at a user device 106. In some embodiments, heatmap generation module 118 may provide a generated heatmap to image classifier module 120, image segmenter module 122, or both.

Image classifier module 120 may be configured to take heatmap images produced by the heatmap generation module 118 and “classify” the image by producing a type or label for the image. In particular, the image classifier module 120 may evaluate heatmap images to determine how well an image may be processed or parsed by an image segmenter module 122. For example, the image classifier module 120 may be provided a plurality of heatmap images, each at a different zoom level, and therefore each having a different map entry density. The image classifier module 120 may score or rank the images based on how well an image segmenter 122, for each image, may be able to determine groupings of properties having similar attribute properties based on the heatmap colors. If an image is too zoomed in, the map entries may be too sparse for an image segmenter 122 to recognize “neighborhoods” or geographic clusters of similar map entries, while if an image is too zoomed out, the details and contours of map entry groupings may become less defined. In some examples, the image classifier module 120 may give the highest score to a most zoomed-in image that is likely to provide sufficient map entry density to allow image segmentation grouping. The image classifier module 120 may be implemented as a convolution neural network (CNN), and in some examples may be implemented as a binary classifier (e.g., configured to classify images into two categories, either well-suited for image segmentation or not). The image classifier module 120 may be a CNN model that may be trained on images that are labeled as either good for image segmentation or poor for image segmentation. The top-scoring zoom level heatmap images (e.g., the top-scoring single image, or the three top-scoring images) may be provided to segmenter module 122.

In some embodiments, direct data (e.g., from map data records 108) may not be available for the type of map element grouping a user desires. For example, a year-over-year value change attribute may provide heatmaps that produce reliable value-based groupings for real estate properties, for identifying high-quality comparable properties. However, in some jurisdictions, year-over-year value change data may be unavailable, or may be unreliable based on local tax laws. In order to identify the same property value groupings, combinations of heatmaps of multiple other attributes (e.g., gross living area, year built, etc) may be used. Image classifier module 120 may be trained to correlate heatmaps for other attributes with year-over-year value change heatmaps (or quality property value grouping heatmaps). Accordingly, a trained image classifier module 120 may take as input heatmap images for more than one selected attribute, and may be configured to produce a composite heatmap from those individual images that reflects a property value grouping heatmap. In this manner, the polygon map delineation server 102 may produce map entry groupings for a desired attribute, even if map data records 108 for that particular attribute are unavailable. In some embodiments, generating a single map entry grouping from multiple different attribute heatmaps may be performed by segmenter module 122 instead of image classifier module 120.

Segmenter module 122 may receive heatmap images, and perform image segmentation on the images to define groups of map entries. Image segmentation may be the process of evaluating individual pixels of an image in order to partition a digital image into multiple image segments, also known as image regions or image objects (each comprised of sets of pixels). Image segmentation may involve the process of assigning a label to every pixel in an image such that pixels with the same label share certain characteristics. Image segmentation may be used to identify objects and boundaries (lines, curves, etc.) in images. In the proposed implementation, segmenter module 122 may be configured to evaluate heatmap images in order to delineate the boundaries of one or more groupings of map elements (e.g., real estate properties) based on selected attributes. For example, evaluating a heatmap of a year-over-year value change attribute of properties may enable the segmenter module 122 to identify “neighborhoods” of properties that share pricing trends, allowing for the identification of highly relevant comparable properties for appraisal and pricing estimates.

Segmenter module 122 may identify the contours of a map grouping that includes a selected target map entry, or may be configured to split the entire map into regions. Once the pixels of the heatmap have been evaluated and labeled into one or more groups, the segmenter module 122 may draw polygonal boundaries around one or more of the map groupings (e.g., geographic clusters). The vertices of a polygonal boundary may be marked via pixel locations, which pixel locations may be converted into latitude and longitude coordinates for the corresponding map points.

Segmenter module 122 may comprise one or more algorithmic models, such as classical computer visional models or artificial intelligence (AI) based models, such as a convolutional neural network (CNN). In some embodiments, the segmenter module 122 may be trained on labeled data of heatmaps, in order to teach the model how best to identify relevant map entry groupings.

Image segmenter module 122 may receive heatmap images that include both color elements for the map entries as well as the underlying map itself, or may receive images that include only the color points of the map entries, and do not include the underlying map information. Image segmenter module 122 may perform better or worse based on how spread out the map entries (and their corresponding pixel representations) are, how concentrated similar-colored map entries are, or how homogenous or heterogeneous the heatmap color distribution of the map entries is. Accordingly, receiving multiple images at segmenter module 122 corresponding to different zoom levels (and therefore different map entry densities) may produce different image segmentation results. Further, segmenter module 122 may be configured to produce more than one object guess or estimate per image, which may be based on a selected target point on the map. For example, if a user were to select a point on an image of a dog sitting on a bench that was within the dog's ear, a segmenter may produce one outline of the dog's ear, one outline of the entire dog, and one outline of the bench and dog together. In the case of map entries on a heatmap, a segmenter may be more or less selective about what entries and what colors to include in a geographic clustering boundary in its various “guesses” about what “object” is being selected. Accordingly, segmenter module 122 may be configured to receive a single heatmap image and produce a single polygonal boundary, or it may be configured to receive multiple heatmap images and produce multiple boundaries for each image. For example, if the image segmenter 122 receives three images of a heatmap at different zoom levels along with a selected target entry or map point, and the segmenter module 122 is configured to produce three polygonal boundary estimates per image, the segmenter may output nine total proposed polygonal boundaries. The output polygonal boundary data may be provided to scoring function 124, display system 116, or other elements. For example, if the segmenter is configured to output a single polygonal boundary or a single collection of polygons segmenting map entries into geographic clusters, then the output may be provided directly to display system 116 for display to a user, without the need for a scoring function 124.

Scoring function 124 may be configured to receive a plurality of polygonal boundary proposals from segmenter module 122, and evaluate or rank them to determine which boundary proposal is likely the most useful or appropriate. The scoring function 124 may rate the polygons based on underlying data of the map entries that fall within the polygon, such as based on map data records 108. In some embodiments, scoring function 124 (or segmenter 122, display system 116, heatmap generation module 118, or another component) may convert the pixel coordinate boundaries of the proposed polygons into latitude and longitude coordinates, and then determine which map entries fall within the polygon based on the latitude and longitude information. The scoring function may then compare details of the included map entries for the various proposed polygonal boundaries to perform the ranking or scoring process. The criteria on which the polygons are scored may be based on the purpose of the grouping or geo clustering application. For example, for determining price neighborhoods of real estate properties, an optimal neighborhood may have an approximate minimum and maximum number of properties included within the neighborhood, to provide a sufficient number of comparable properties that have been sold recently. Accordingly, scoring function 124 may provide a higher score to polygons that include a number of map entries within a selected range. Similarly, in order to identify similar properties, scoring function 124 may evaluate how many or what ratio of included properties have the selected heatmap attribute(s) within a similar range, to prioritize clusters of homogenous map entries for that attribute. In some examples, the scoring function 124 may also evaluate other attributes besides a selected heatmap comparison attribute, such as providing higher scores when included properties have similar square footage, year built, gross living area, features like attached garages, single-or multi-level dwellings, single-family homes vs. apartments, or other criteria to ensure the included properties are as homogenous as possible. The scoring function may compare a selected map entry to the other included properties, to evaluate whether the grouped properties are as similar as possible to the selected property, as opposed to merely being similar to each other but not similar to the selected property. Other scoring or evaluation metrics may also be used. The polygonal boundary that receives the highest score or ranking may be provided to display system 116, from which it may then be displayed via web front-end 104 on user device 106. In some embodiments, display system 116, via UI 126, may enable a user to manually adjust the vertices, and therefore overall shape and position, of the presented polygon, allowing for further refinement of the selected region and the included map entries.

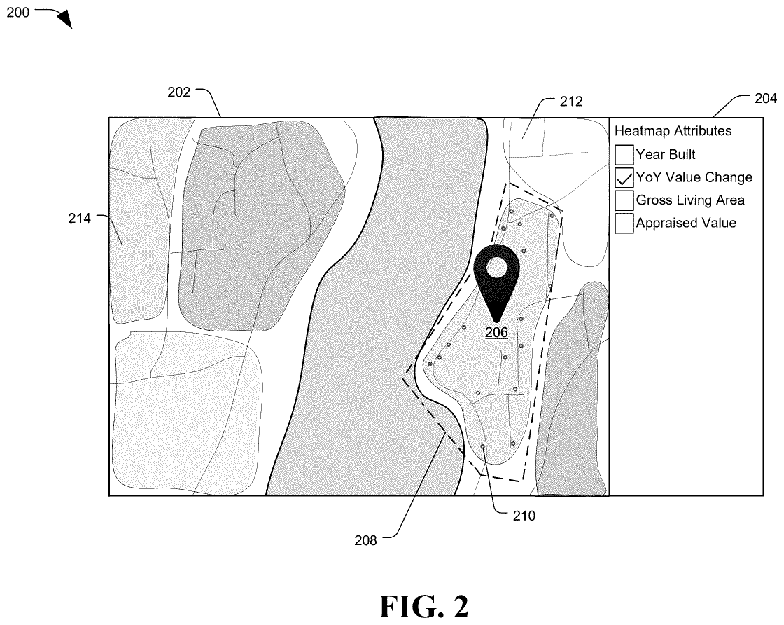

Using modules from the system 100 proposed herein may solve the technical problem of identifying and proving an outline of a geographic cluster of related or relevant map entries, based on one or more selected attributes, automatically and on-the-fly. The system may harness large data pools, computer vision, and machine learning to produce detailed and accurate polygonal selections of map entries, such as real estate properties, according to user-selected or pre-configured attributes. An example graphical user interface (GUI) display of a system for automated polygon selection of a map region is described in regard to FIG. 2.

FIG. 2 depicts an example user interface 200 for a system configured to perform automated polygon selection of a map region, in accordance with certain embodiments of the present disclosure. The UI 200 may include a map display 202, and a heatmap attribute selection bar 204. The interface 200 may be generated or populated by a polygon map delineation server or service 102, and may be presented via web front-end 104 as a UI 126, as described in regard to FIG. 1.

UI 200 may include a map depiction 202, which may show a geographical region or map area that may contain map entries 210, such as real estate properties. Heatmap attribute sidebar 204 may provide a plurality of attributes for the map entries based on which a heatmap may be generated. In the depicted example, sidebar 204 includes attribute options such as year built, year over year (YoY) value change, gross living area (GLA), and appraised value, which may be values associated with many or all real properties depicted on map 202. By selecting an attribute from sidebar 204, each map entry may be assigned a color according to the attribute value for that map entry. In some examples, this may produce a heterogenous distribution of color, while in other examples it may produce relatively homogeneous groupings of map entries, such as groupings 212 and 214. If a user selects multiple attributes from sidebar 204, the UI may produce a composite heatmap that takes into account each selected attribute.

A user may utilize the map 202 to select a target map entry or location 206, which may be used by a polygon map delineation system as a basis to determine a region or group of map entries to select with a polygonal boundary 208. For example, once a user has selected a desired attribute from heatmap attribute bar 204 to produce a heatmap representation of the map entries on map display 202, and selected a target map entry or location 206, a polygon map delineation service may use an image segmentation algorithm to evaluate the heatmap and create a polygonal boundary 208 around an “island” or “neighborhood” of similarly-colored properties 210 including the selected target location 206.

In some examples, the heatmap as viewed by the user on display 202 may be segmented directly. However, as previously described, the system may be configured to evaluate the displayed heatmap 202 at multiple zoom levels to determine one or more zoom level representations of the map entries 210 most likely to be handled well by the image segmenter, such as by evaluating which zoom levels have a sufficient colored pixel density to provide recognizable groupings 212, 214. Evaluating different zoom levels may involve locking the map entries 210 to the heatmap color they received at the user's selected zoom level visible on display 202. In other examples, different zoom levels may result in different color distributions among the depicted map entries 210, as zooming in or out may hide or reveal additional map entries, respectively, and therefore change the distribution of map entry 210 asset values displayed.

The segmentation algorithm may be configured to produce one or more polygonal boundary proposals for each heatmap zoom level received. For example, if the segmenter receives only a single heatmap image and is configured to produce a single polygonal estimate, that polygon selection 208 may be displayed on map 202 directly. However, if the segmenter is configured to produce multiple polygonal estimates (e.g., from receiving multiple heatmap images, from being configured to produce multiple polygons per image, or both), the polygonal proposals may be provided to a scoring algorithm for evaluation.

A scoring algorithm may evaluate polygons based on multiple factors, such as size or distance around map selection 206, or evaluating data associated with map entries 210 included within each polygon. For example, the pixel coordinates of the polygon produced by the segmenter may be converted to latitude and longitude coordinates, which may be used to determine which map entries lie within the polygon. The scoring algorithm may then evaluate how homogenous each included map entry 210 is for the selected target attribute from sidebar 204, look at other attribute values, or a combination thereof. The scoring algorithm may also consider how many map entries are included within each polygon, and may favor polygons that include a selected number or range of map entries (e.g., providing a higher score for polygons including closer to one thousand entries). The polygonal proposal receiving the highest score or rank from the scoring algorithm may be depicted on map display 202 as a polygonal boundary 208 around the target neighborhood or geographic cluster of similar map entries 210. In some examples, a user may utilize the UI to adjust the corners or contours of the polygonal boundary 208, to further tweak the included region.

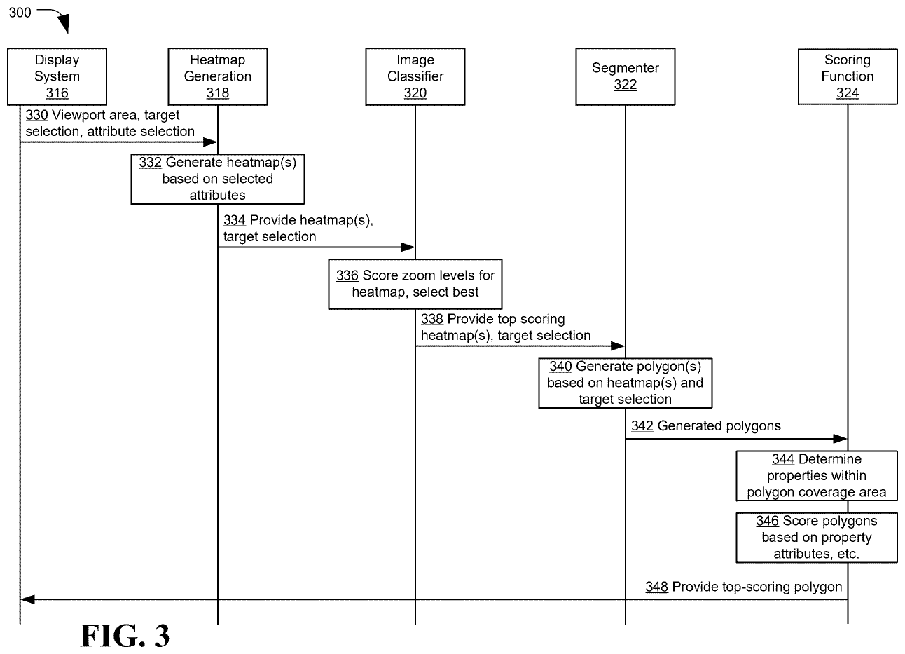

The map entries 210 included within the polygonal border 208 may be highlighted or selected, and may be searched independently of map entries outside of the polygon 208. In this manner, a search for relevant comparable real property sales to the selected target property 206 may be performed, and may produce highly relevant results. An example flow diagram for automatically generating a geographic clustering polygonal map boundary is described in regard to FIG. 3.

FIG. 3 depicts an example process flow diagram 300 of a system configured to perform automated polygon selection of a map region, in accordance with certain embodiments of the present disclosure. In particular, flow diagram 300 provides an example data exchange and processing operations of components of an example polygon map delineation server, such as polygon map delineation server 102 of FIG. 1. Flow diagram 300 may include a display system 316, heatmap generation module 318, image classifier module 320, segmenter module 322, and scoring function module 324, which may correspond to elements described in regard to FIG. 1.

At 330, display system 316 may receive data from a UI of a web interface, and pass at least some of the data to heatmap generation module 318, such as a displayed viewport area, zoom level, a target map entry or location selection, and one or more attributes on which to generate a heatmap. At 332, heatmap generation module 318 may use at least some of the data to generate a heatmap image, such as the selected attribute, the viewport area, and the zoom level. In some embodiments, heatmap generation module 318 may retrieve attribute values for depicted map entries from a data source, such as a local file system 114 or map data records system 108 of FIG. 1, and use those attribute values to determine what heatmap colors to assign to each displayed map entry. In some embodiments, heatmap generation module 318 may generate multiple heatmap images, such as a heatmap image per each of one or more zoom levels, heatmaps corresponding to multiple user-selected attribute values, or other multi-heatmap image scenarios.

At 334, heatmap generation module 318 may provide the one or more generated heatmap images and the target map entry or location selection to image classifier module 320. At 336, image classifier module 320 may evaluate and score heatmap images from different zoom levels, to determine which heatmap images an image segmenter is most likely to be able to parse well and will produce an accurate polygonal boundary. The one or more top-scoring or highest-ranked heatmaps may be selected for segmenation. For example, the image classifier module 320 may evaluate how dense the map entries (and corresponding color pixels) are on the map, how well the fine details of a grouping may be recognized when zoomed out far, other factors, or a combination thereof. In some examples, image classifier module 320 may evaluate a plurality of heatmaps corresponding to multiple selected attributes, and may generate a single composite heatmap image that factors in the multiple attribute values, although in other embodiments this operation may be performed at heatmap generation module 318 or segmenter module 322.

At 338, image classifier module 320 may provide the top scoring heatmap image or images, and potentially other information such as a target map entry or location selection, to segmenter module 322. At 340, segmenter module 322 may evaluate a heatmap image and partition the pixels into discreet groups, such as by assigning a group label to each pixel based on color distributions across the image. In some embodiments, segmenter module 322 may partition the entire image into discreet groups, while in other embodiments segmenter module 322 may focus on a group including the target selection. Segmenter module 322 may generate a polygonal selection boundary around the group of pixels including the target selection. In some embodiments, segmenter module 322 may generate a single polygonal boundary per heatmap image, while in other configurations it may produce multiple polygonal boundary estimates, corresponding to different groupings of pixels, per heatmap image. If the segmenter module produces only a single polygon, it may provide the polygon details to display system 316 for presentation to a user (not shown).

At 342, segmenter module 322 may provide a plurality of generated polygons to scoring function module 324. At 344, scoring function 324 may determine which map entries (e.g., real estate properties) that fall within the polygon coverage area, for example by converting the pixel coordinates of the polygon boundaries to latitude and longitude coordinates, and then comparing those boundaries to the latitude and longitude coordinates of individual map entries. After determining which properties fall within the polygonal boundary, at 346 the scoring function module 324 may evaluate or score the polygonal boundaries based on attribute values of properties or map entries that fall within the polygon coverage area, a number of map entries within the polygon, a size of the polygon, or other considerations. For example, there may be a minimum, maximum, or optimal number or range of map entries that should be included in a polygon, an optimal polygon size, a preferred distance the polygon may extend away from the target selection, or other polygon attribute considerations. Similarly, the scoring function module 324 may look for which polygons have the most homogenous attribute values for one or more attributes, including both user-selected attributes (e.g., for the heatmap generation) or default comparison attributes, such as lot size, year built, or other attributes.

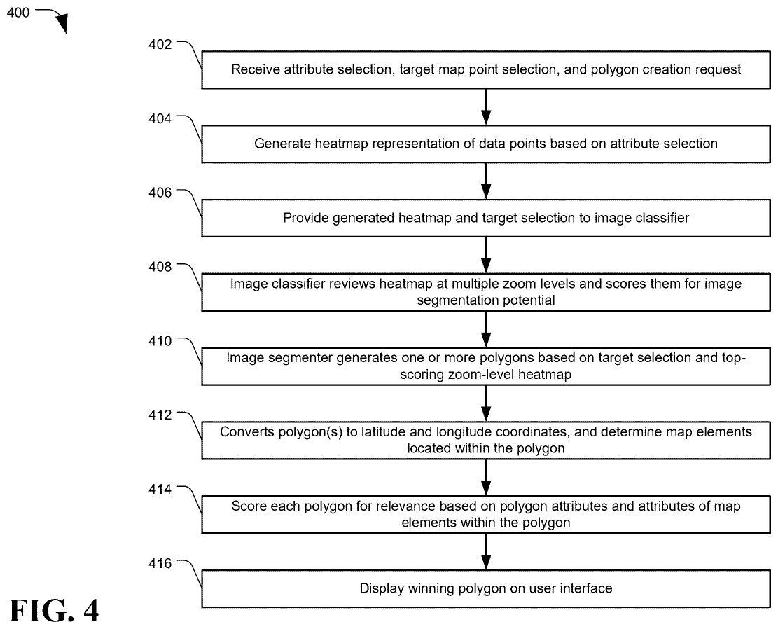

At 348, scoring function 324 may provide the top-scoring polygon to display system 316. Based on the polygon information, display system 316 may generate a polygonal outline on a visual display of a user interface for presentation to a user. The creation of a polygon on the display may highlight or selection map entries within the polygon. The display system 316 may also allow a user to manually modify or adjust the contours of the presented polygon, and thereby modify which map entries fall within the boundary. Highlighting or selecting map entries within the polygon may allow a user to perform refined searches or data collection on the outlined map grouping. For example, a user may search for highly relevant comparable properties for performing appraisals or valuation estimates from only the selected “neighborhood” of properties, thereby greatly improving comp searches and valuation appraisals performed manually or by other approaches. A flowchart of a process for producing polygonal map selections is described in regard to FIG. 4.

FIG. 4 depicts a flowchart 400 of an example method for automated polygon selection of a map region, in accordance with certain embodiments of the present disclosure. In particular, flowchart 400 provides an example process for generating a heatmap for a selected attribute of map entries, and automatically performing geographic clustering via a polygonal boundary based on segmentation of the heatmap image, as described herein. The method of FIG. 4 may be implemented via systems and computing devices such as those depicted in FIG. 1 and FIG. 3.

The method may include receiving an attribute selection, target map point or map entry selection, and an instruction to create a polygon boundary around a geographic cluster or “neighborhood” of map entries for the selected target and attribute, at 402. The inputs may be provided to a polygon map delineation server or service via a user interface of a web front-end or other computing interface.

At 404, the method may include generating a heatmap representation of map entry data points based on the attribute selection. For example, the method may include determining what map entries are displayed on a viewport screen, and determining the range of values for the selected attribute for the displayed map entries. The map entries may then be categorized into color buckets or groups based on their corresponding attribute values, in order to make a color-coded heatmap for the selected attribute. In some examples, the method may include generating multiple heatmaps, such as heatmaps generated at multiple zoom levels, which in turn may produce different densities of map entry points, different resolutions on fine details of map entry distribution, and potentially different heatmap color distributions based on more or fewer map entries being depicted.

At 406, the method may include providing the generated heatmap image(s) and target selection to an image classifier. The image classifier may review the heatmaps for multiple zoom levels, and score them for image segmentation potential, at 408. The one or more heatmaps best suited for image segmentation may be provided to an image segmenter or segmentation model. Alternately, one or more generated heatmaps may be sent directly to an image segmenter, without scoring or ranking them at an image classifier.

At 410, the image segmenter may evaluate the one or more received heatmap images, based on the target selection, and generate one or more polygon to delineate a geographic cluster or grouping of map entries including the target selection. For example, the image segmenter may perform segmentation on one or more heatmap images, and may produce one or more polygon grouping estimates per heatmap image. The polygon estimates may comprise pixel coordinates for the polygon vertices.

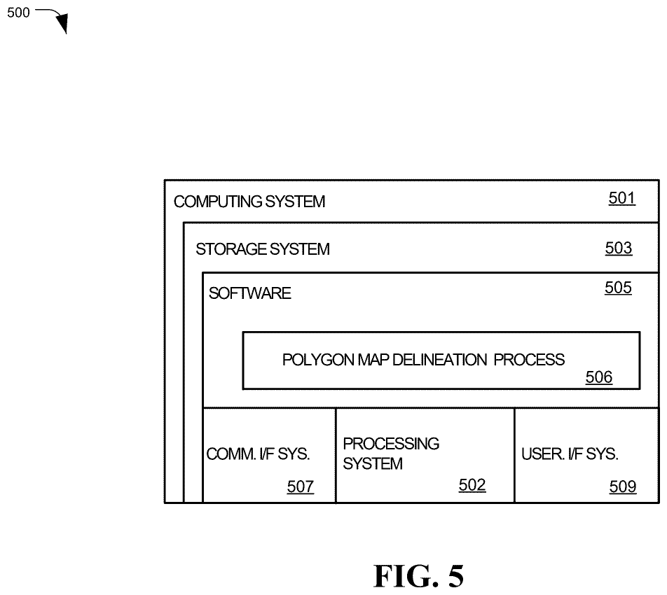

At 412, the method may comprise converting the polygon(s) to latitude and longitude coordinates, and determining which map entries lie within each of the polygon estimates. Based on the polygon size, shape, position, or other attributes, and the attributes of map elements within the polygon, the method may include scoring each polygon for relevance, at 414. Relevance may be based on the selected heatmap attribute, as well as other factors considered relevant for the type of map entries being grouped. For example, other attributes beyond the selected attribute that may indicate greater homogeneity among map entries may result in a higher polygon score. In embodiments where only a single polygon is produced, there may not be a need to score multiple polygons to select a best or “winning” polygon. When one polygon proposal remains, that polygon may then be displayed on a graphic display or user interface representation of the map. The polygon may surround a group or neighborhood of similar map elements, and in some embodiments may highlight or select those map elements, isolate the map elements for more specific searches or evaluation, or otherwise focus the included map elements. An example system configured for automated polygon selection of a map region is described in regard to FIG. 5.

FIG. 5 is a diagram of an example system 500 configured to implement automated polygon selection of a map region, in accordance with certain embodiments of the present disclosure. System 500 may be an example of an apparatus including a computing system 501 that is representative of any system or collection of systems in which the various processes, systems, programs, services, and scenarios disclosed herein may be implemented. For example, computing system 501 may be an example polygon map delineation server 102, web front-end 104, user device 106, map data sources 108, or any of the subcomponents depicted in system 100 of FIG. 1. Examples of computing system 501 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 501 may be implemented as a single apparatus, system, or device or may be implemented in a distributed manner as multiple apparatuses, systems, or devices. Computing system 501 may include, but is not limited to, processing system 502, storage system 503, software 505, communication interface system 507, and user interface system 509. Processing system 502 may be operatively coupled with storage system 503, communication interface system 507, and user interface system 509.

Processing system 502 may load and execute software 505 from storage system 503. Software 505 may include and implement polygon map delineation process 506, which may be representative of any of the operations for defining attributes by which to group map entries, producing a heatmap representation of map entries based on the selected attributes, performing image classification on heatmap images to identify those suited for image segmentation, performing image segmentation on heatmap images to identify the boundaries of a group of related map entries and reflect those boundaries via a polygonal shape, evaluating map entries within polygonal boundaries to identify a most relevant polygon, and displaying the polygon for map entry grouping on a display, as discussed with respect to the preceding figures. When executed by processing system 502, software 505 may direct processing system 502 to operate as described herein for at least the various processes, operational scenarios, and sequences discussed in the foregoing implementations. Computing system 501 may optionally include additional devices, features, or functionality not discussed for purposes of brevity.

In some embodiments, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 may include general purpose central processing units, graphical processing units, application specific processors, and logic devices, as well as any other type of processing device, combinations, or variations thereof.

Storage system 503 may comprise any memory device or computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including polygon map delineation process 506 among other functions) may be implemented in program instructions that may, when executed by processing system 502, direct processing system 502 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
executing a polygon map delineation operation via a computing system to perform automated geographic clustering based on computer vision at runtime, including:
generating a heatmap image of a plurality of map entries based on a selected attribute, including assigning colors to the map entries based on their corresponding value for the selected attribute;
performing image segmentation on the heatmap image to determine a grouping of map entries sharing similar values for the selected attribute;
generating a polygon boundary around the grouping of map entries; and
performing operations limited to the grouping of map entries based on the polygon boundary.

2. The method of claim 1 further comprising:
receiving a target selection of a particular map entry; and
determining the grouping of map entries that includes the particular map entry.

3. The method of claim 2 further comprising:
the plurality of map entries include real estate properties; and
generating a comp list of sales of comparable properties to the particular map entry within the polygon boundary.

4. The method of claim 3 further comprising:
producing a plurality of heatmap images including the heatmap image, the plurality of heatmap images including views of a map at different zoom levels;
scoring the plurality of heatmap images using an image classifier, the scoring based on which of the plurality of heatmap images best suited to image segmentation; and
performing image segmentation on the heatmap image receiving a highest score.

5. The method of claim 4 further comprising:
generating a plurality of polygon boundaries including the polygon boundary; and
applying a scoring function to the plurality of polygon boundaries to determine the polygon boundary, the scoring function considering attribute values of map entries within each of the polygon boundaries.

6. The method of claim 5 further comprising:
performing image segmentation on multiple of the plurality of heatmap images receiving highest scores; and
generating a polygon boundary corresponding to each of the multiple of the plurality of heatmap images.

7. The method of claim 6 further comprising:
defining the polygonal boundary via pixel coordinates;
converting the pixel coordinates to latitude and longitude coordinates; and
using the latitude and longitude coordinates to determine map entries included in the grouping of map entries.

8. A memory device storing instructions that, when executed, cause a processor to:
execute a polygon map delineation operation via a computing system to perform automated geographic clustering based on computer vision at runtime, including:
generate a heatmap image of a plurality of map entries based on a selected attribute, including assigning colors to the map entries based on their corresponding value for the selected attribute;
perform image segmentation on the heatmap image to determine a grouping of map entries sharing similar values for the selected attribute;
generate a polygon boundary around the grouping of map entries; and
perform operations limited to the grouping of map entries based on the polygon boundary.

9. The memory device of claim 8 storing instructions that, when executed, cause the processor to further:
receive a target selection of a particular map entry; and
determine the grouping of map entries that includes the particular map entry.

10. The memory device of claim 9 further comprising:
the plurality of map entries include real estate properties; and
the instructions, when executed, cause the processor to further generate a comp list of sales of comparable properties to the particular map entry within the polygon boundary.

11. The memory device of claim 8 storing instructions that, when executed, cause the processor to further:
produce a plurality of heatmap images including the heatmap image, the plurality of heatmap images including views of a map at different zoom levels;
score the plurality of heatmap images using an image classifier, the scoring based on which of the plurality of heatmap images best suited to image segmentation; and
perform image segmentation on the heatmap image receiving a highest score.

12. The memory device of claim 11 storing instructions that, when executed, cause the processor to further:
perform image segmentation on multiple of the plurality of heatmap images receiving highest scores; and
generate a polygon boundary corresponding to each of the multiple of the plurality of heatmap images.

13. The memory device of claim 8 storing instructions that, when executed, cause the processor to further:
generate a plurality of polygon boundaries including the polygon boundary; and
apply a scoring function to the plurality of polygon boundaries to determine the polygon boundary, the scoring function considering attribute values of map entries within each of the polygon boundaries.

14. The memory device of claim 8 storing instructions that, when executed, cause the processor to further:
define the polygonal boundary via pixel coordinates;
convert the pixel coordinates to latitude and longitude coordinates; and
use the latitude and longitude coordinates to determine map entries included in the grouping of map entries.

15. An apparatus comprising:
a processor; and
a memory device storing instructions that cause the processor to execute a polygon map delineation operation to perform automated geographic clustering based on computer vision at runtime, including:
generate a heatmap image of a plurality of map entries based on a selected attribute, including assigning colors to the map entries based on their corresponding value for the selected attribute;
perform image segmentation on the heatmap image to determine a grouping of map entries sharing similar values for the selected attribute;
generate a polygon boundary around the grouping of map entries; and
perform operations limited to the grouping of map entries based on the polygon boundary.

16. The apparatus of claim 15, further comprising the processor configured to execute the instructions to:
receive a target selection of a particular map entry; and
automatically determine the grouping of map entries that includes the particular map entry and generate the polygon boundary based on the target selection.

17. The apparatus of claim 16, further comprising the processor configured to execute the instructions to:
the plurality of map entries include real estate properties; and
the instructions, when executed, cause the processor to further generate a comp list of sales of comparable properties to the particular map entry within the polygon boundary.

18. The apparatus of claim 15, further comprising the processor configured to execute the instructions to:
produce a plurality of heatmap images including the heatmap image, the plurality of heatmap images including views of a map at different zoom levels;
score the plurality of heatmap images using an image classifier, the scoring based on which of the plurality of heatmap images best suited to image segmentation; and
perform image segmentation on the heatmap image receiving a highest score.

19. The apparatus of claim 18, further comprising the processor configured to execute the instructions to:
perform image segmentation on multiple of the plurality of heatmap images receiving highest scores; and
generate a polygon boundary corresponding to each of the multiple of the plurality of heatmap images.

20. The apparatus of claim 15, further comprising the processor configured to execute the instructions to:
generate a plurality of polygon boundaries including the polygon boundary; and
apply a scoring function to the plurality of polygon boundaries to determine the polygon boundary, the scoring function considering attribute values of map entries within each of the polygon boundaries.
